(19) United States
(12) Patent Application Publication
(10) Pub. No.: US 2004/0124648 A1
(43) Pub. Date: Jul. 1, 2004

(54) Object gripping device

(76) Inventor: Steven A. Williams, Thousand Oaks, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/329,659

(22) Filed: Dec. 26, 2002

(51) Int. Cl. B66C 1/42

(52) U.S. Cl. 294/86.4; 294/119.2

(57) ABSTRACT

A gripper device for loosening, tightening or gripping objects. The gripper device has a support structure with a fixed, object contact surface, that preferably has a high friction surface. One end of a pivot arm is pivotally attached to the support structure. The pivot arm has a free end. A cinch strap with two ends is provided. On end of the cinch strap is attached to the free end of the pivot arm and another end of the cinch strap is fixed to the structure. By moving a jar or other cylindrical object into turning contact with the cinch strap, that object will be captured and held in place.

### BACKGROUND OF THE INVENTION

This invention relates primarily to the field of kitchen utensils, in general, and in particular to devices for loosening or breaking the vacuum seal on jars or containers with threaded lids. Other uses include, tightening or loosening pipes or rods, such as in plumbing applications, offshore oil rigs, nuclear facilities, biological laboratories, construction sites, and for other uses. The gripper device can also be used for lifting and carry pipes or a bundle of pipes (or semi-round objects), e.g., with a fork lift or a crane lift. The invention can be mounted on a robotic arm and used in all axis, which could be used in a factory, for example, to grip, lift, move, or rotate any sized semi-round parts. A hand held version can be used for mobile tasks, requiring no adjustment by the user to accommodate various sized pipes or the like.

Prior strap wrench are not ideally suited to open jars and grip objects of varying sizes because they generally simply include just a strap attached to one end of the tool with the length changed at the strap's other end, and adjustable by the user to accommodate different tasks. Present strap wrenches require the strap to be freed and slipped over the object to be rotated and reattached to the wrench in those situations where the wrench cannot slip over the object to be rotated. Furthermore, current strap wrench designs dictate that the user loosen the strap, rewind the wrench, and then tighten the strap again to proceed with additional wrenching.

Prior gripping and opening devices have elaborate jaw gripping system with teeth to grasp the lid. The drawback of using the jaws or similar methods is possible damage to the lid from the gripping teeth and a high manufacturing cost due to the intricate parts. Other drawbacks for existing lid looseners are that they are often hand held, are clumsy, and are expensive.

### BRIEF SUMMARY OF THE INVENTION

The invention can be used to unscrew jar or container lids, especially those that are difficult to open, such as those that are pressure sealed. Individuals lacking physical strength, as well as those who suffer from arthritis, or an injury to the hands, wrists, arms or shoulders may find it difficult, if not is impossible, to open a pressure sealed jar. Such individuals may further risk injury to their wrists or body while exerting force to open a jar or container. Also, during opening the jar may also slip off the counter top, and if a glass jar, can shatter and risk injuring someone else. The invention is adapted to accept jars or container lids of various sizes and requires no conscience adjustment by the user to do so.

The invention consists of a fixed portion and a pivoting arm used to grip any size jar lid. A cinching strap is positioned between the two points just mentioned. The pivoting arm is positioned so that a rotating force will create a tight, self-adjusting grip on the jar lid by the use of the cinching strap. The torque exerted on the lid is a function of the cinching strap's friction and the amount of rotating force provided by the user. As the jar is rotated by the user, the torque on the lid equals the rotational force provided (assuming no slippage between lid and cinch strap). The inventor's designs will enable the user to use both hands to hold and rotate the jar while the lid is securely gripped by the device.

The gripping device may be mounted to the underside of a cabinet, a vertical edge of a counter or closet wall, a drawer or any fixed surface. The gripping device will operate in any orientation the user desires, such as vertically or horizontally. The gripping device can swing from a stowed position to a vertical or horizontal position with the use of a hinge. The gripping device can also be used to tighten lids or objects securely by simply flipping the device around.

An embodiment of the gripping device can be incorporated into a hand held tool to grip pipes or the like without user adjustment for different sized pipes or incurring damage to the pipes. The gripping device does not require dismantling prior to use on a pipe. Instead, the user can just insert the pipe and rotate the invented wrench. Also, the pivot arm strap wrench will allow the user to ratchet while tightening or loosening. The invention can be simply flipped over to either tighten or loosen objects.

Another embodiment of the gripping system can be used by robots in factories, production lines, oil rigs, biological facilities, or nuclear facilities, etc., to either loosen or tighten pipes, transport and lift pipes, test tubes, or rods. Such a gripping system comprises two sets of pivot arm gripper devices spaced apart to hold the object. Between the two gripper devices is located a powered drive wheel that can rotate the object to be bound to a secured position. This arrangement can be mounted on a tractor, forklift, robotic arm, or a lifting crane.

### BRIEF DESCRIPTION OF THE DRAWINGS

FIG. 1 is a side view of an exemplary jar with its affixed lid.

FIG. 2 is a top view of an embodiment of the gripper device of the invention having a pivot arm.

FIG. 3 is a top view of the gripper device of FIG. 2 accepting a large jar for loosening of its lid.

FIG. 4 is a top view of the gripper device of FIG. 2 accepting a small jar for loosening of its lid.

FIG. 5 is a top view of the gripper device of FIG. 2 with an aesthetic cover plate.

FIG. 6 is a front view of the gripper device of FIG. 2 mounted under a cabinet.

FIG. 7 is a top view of the gripper device of FIG. 2 modified to include a rocker arm at the tip of the pivot arm and accepting a large jar.

FIG. 8 is a top view of the gripper device of FIG. 7 utilizing a cam at the tip of the pivot arm and accepting a large jar.

FIG. 9 is a top view of another embodiment of a gripper device of the invention in the form of a hand held tool utilizing a rocker arm.

FIG. 10 is a side view of the gripper device of FIG. 9.

FIG. 11 is a top view of another gripper device similar to that of FIG. 9 but equipped with a cam.

FIG. 12 is a side view of the gripper device of FIG. 11.

FIG. 13 is a top view of another embodiment of a gripper device of the invention having a pivot arm attached to a long handle for use as a pipe wrench.

FIG. 14 is a top view of two gripper devices having pivot arms mounted to a fork lift.

FIG. 15 is a side view of a gripper devices of FIG. 19 for mounting on various transporting devices.

FIG. 16 is a side view of an articulating arm with a drive belt for rotating an object and used with gripper devices of FIG. 14.

FIG. 17 is an expanded side view of the drive belt gears of FIG. 16.

FIG. 18 is a top view of the device of FIG. 14 engaging a pipe.

FIG. 19 is a top view of the expanded drive belt.

### DETAILED DESCRIPTION OF THE INVENTION

The purpose of the gripping device of the invention is to grasp objects through the use of a cinching strap and a fixed surface such as a stationary wall. Other embodiments of the gripper device of the invention use a pivoting arm to take up the slack in the cinching strap. The gripper device can be used, for example, to loosen or tighten container and jar lids, as well as to grasp items, such as pipes and rods. The gripper device can be secured on a wall, under a cabinet, or in a drawer. The gripper device can be hinged to allow an angle more suitable to the user. The gripper device's strap will grasp a jar's lid without conscious user adjustment, and allows both of the user's hands to rotate the jar for loosening, thusly doubling the amount of torque available to open a jar. The gripper device can also be used to hold and turn pipes, as well as for transporting, lifting or lowering of pipes or the like.

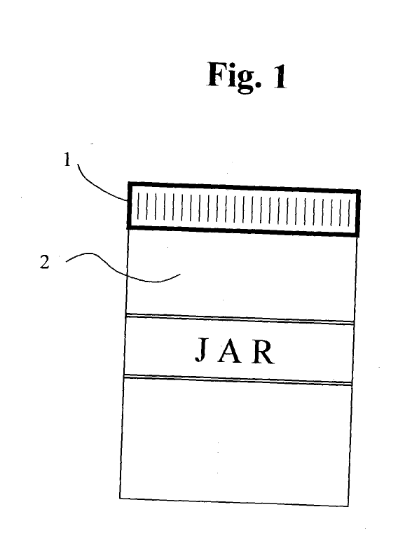

FIG. 1 is a front view of a exemplary, conventional jar 2 and it's lid 1. The gripper device of the invention can be used to loosen the lid on the jar.

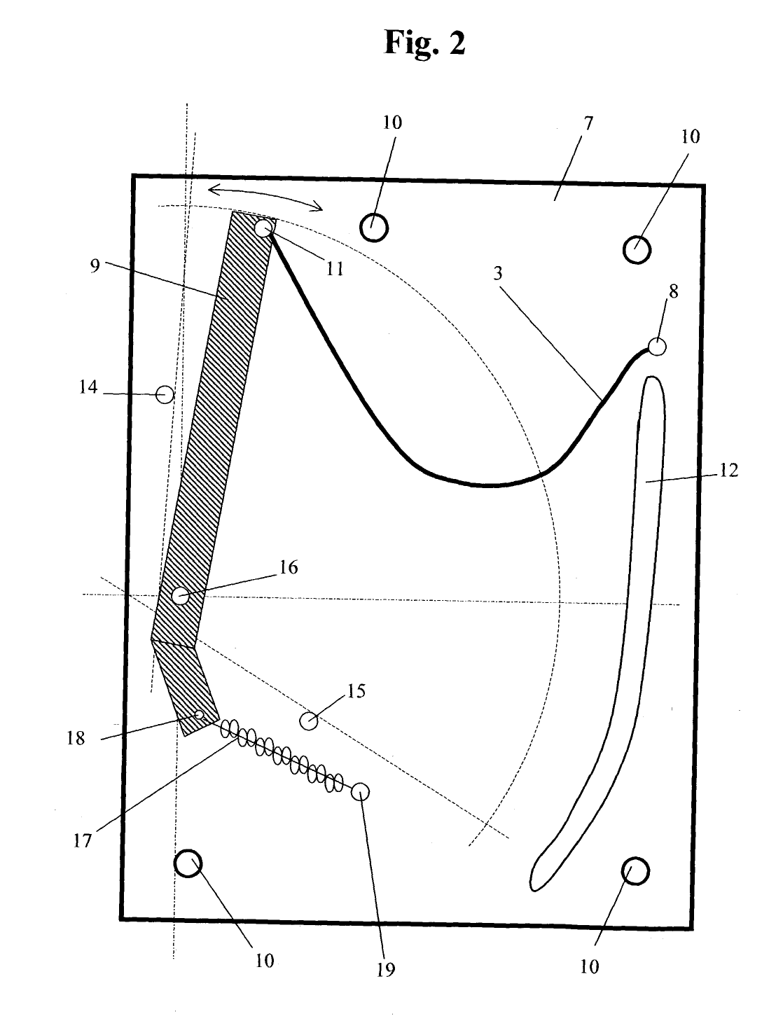

FIG. 2 is a bottom plan view of another embodiment of a gripper device 130 of the invention. Gripper device 130 has a cinching strap 3 mounted at end to a post 8 secured to a base plate 7. The gripper device 130 can be securely mounted on any surface (such as to the underside of a kitchen counter or to the side of a structure), in any axis by means, for example by mounting holes 10 in the base plate 7, although other means can be used. The other end 11 end of the cinching strap 3 is attached to a pivoting arm 9, which pivoting arm is free to swivel about a pivot 16. Another method of mounting the cinching strap 3 in lieu of utilizing a post 8 is to mount the cinching strap 3 onto the top of the fixed ridge 12. The fixed ridge 12 is attached to the baseplate 7 and can extend from it at about a 90 degree angle. The fixed ridge 12 can either be welded, bolted, or if plastic can be integrated with the base plate 7. The fixed ridge 12 preferably follows the arc 132 of the pivoting arm 9 (shown in dashed lines.) The fixed ridge's 12 height is preferably roughly equal to the width of the cinching strap 3, which can be set to be roughly equal to the width of an average jar lid 1. However, so long and the material of the cinch strap 3 is selected so that it has enough tensile strength and friction, it width is not too important. The width of the strap ideally should roughly equal the average width of jar lids. However, if the device is manufactured to grip the base of jars as opposed to their lids, a wider strap 3 would be preferable. The pivoting arm's 9 travel is preferably limited by an upper stop 14 and a lower 15 stop. The purpose of the upper stop 14 is to allow some slack in the strap 3 so it can accept the jar lid 1. The pivoting arm 9 pivots around the attachment point 16, which can be designed with a bearing or bushing to improve longevity and smoothness of operation. A spring 17 or similar method of applying tension is attached to an end of the pivot arm 18, opposite attachment point 11, and at a point 19 located on the base plate 7. The purpose of the spring 17 is to return the pivot arm 9 to the open position (as shown) to allow it to accept the jar's lid 1 to be opened. The base plate 7 not only holds all the pieces together, but also ensures alignment of the cinch strap 3 with the lid 1 and the fixed ridge 12.

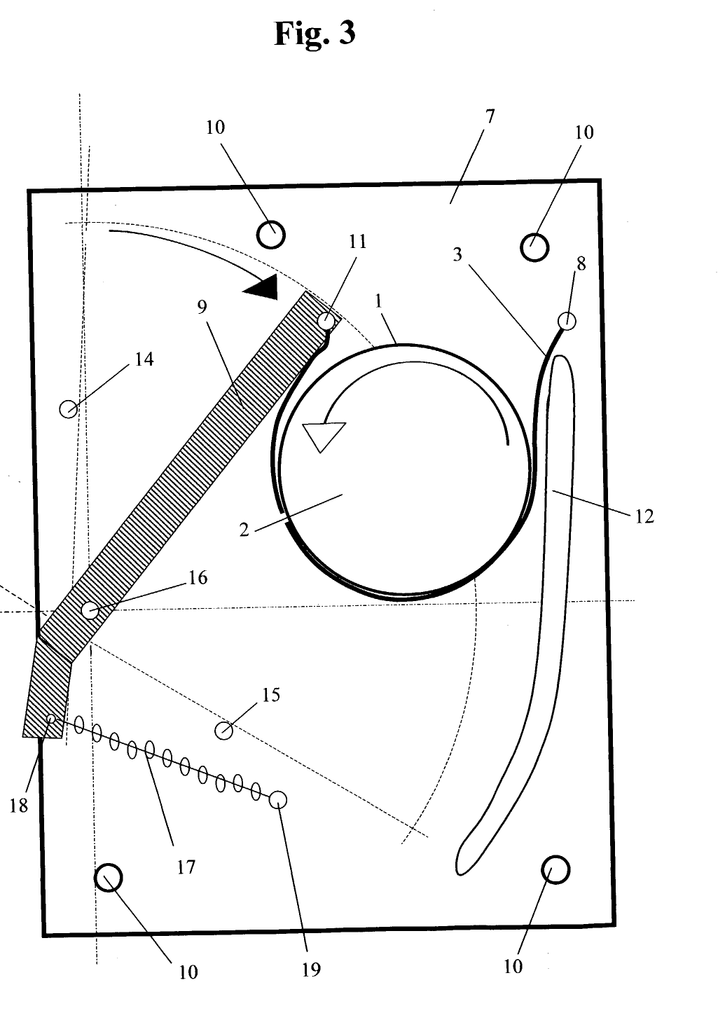

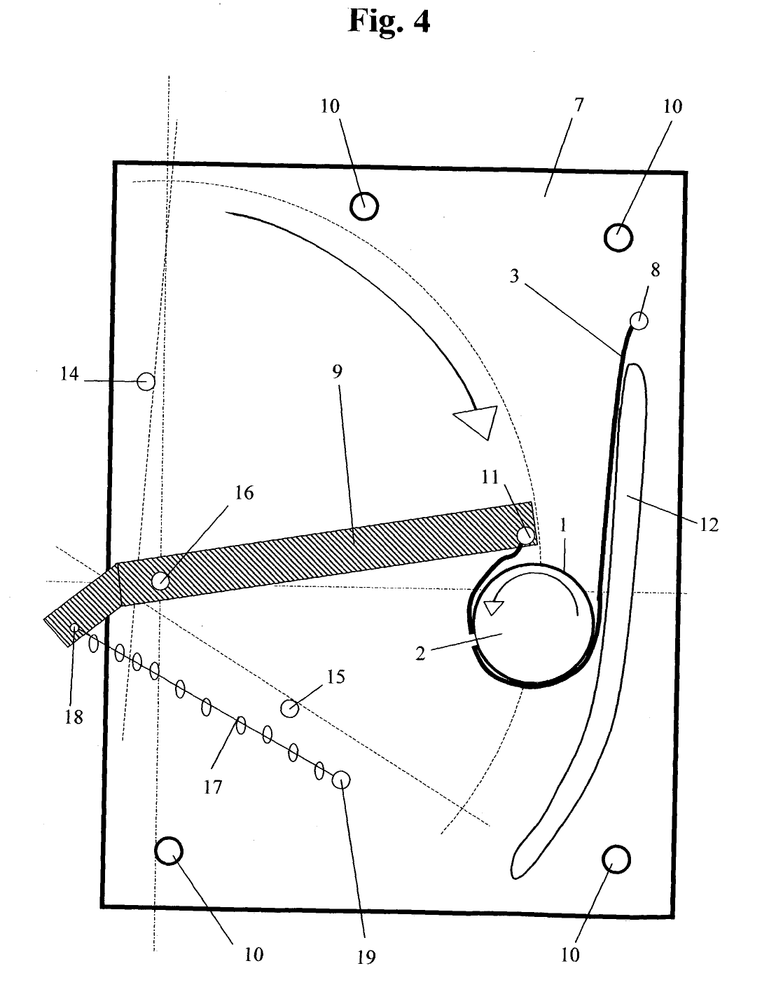

FIG. 3 is a top plan view of the gripper device 130 of FIG. 2 used to open a large diameter lid 1 with no adjustment by the user. To use the gripper device, a user places a jar 2 with its lid 1 face down on base plate 7, and pushes the lid into contact with cinch strap 3. This causes the lid 1 to roll down counterclockwise until the cinching strap 3 is taunt, which in turn causes the pivoting arm 9 to swing down to take up the slack of the cinching strap 3. By continuing to turn the jar 2 counterclockwise, the lid 1 will soon loosen. FIG. 4 is a top plan view of the gripper device 130 of FIG. 2 used to open a smaller diameter lid 1 with no adjustment by the user. The lid 1 rolls down the fixed ridge 12 counter-clockwise until the cinching strap 3 is taught and grips the lid 1. Other features and operations of the device 130 are as shown as in FIG. 2.

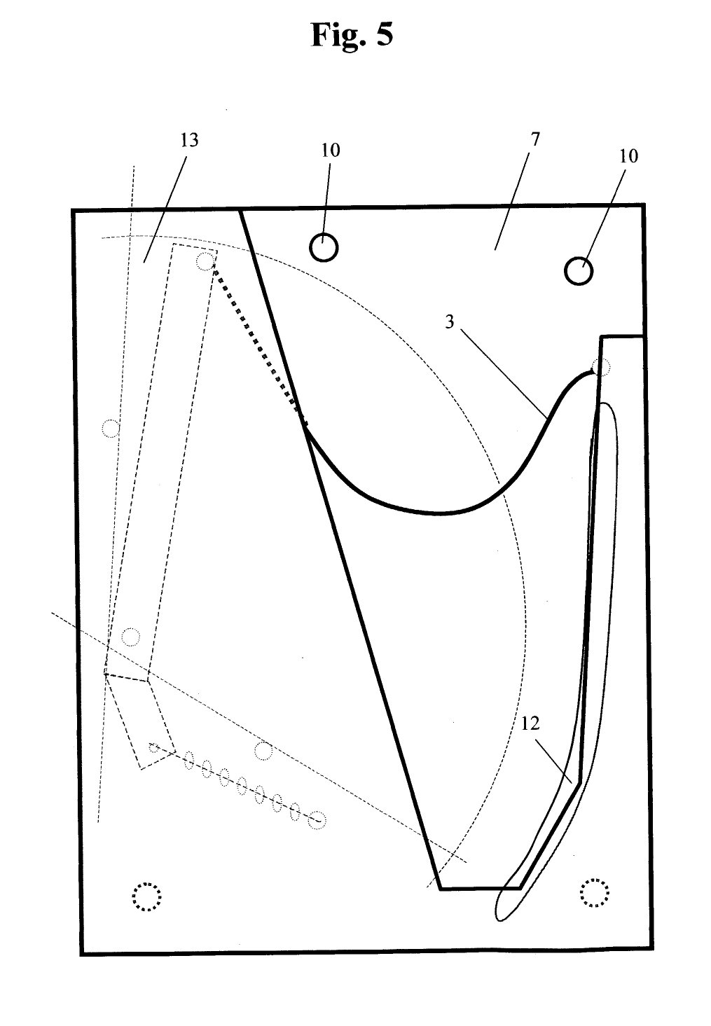

FIG. 5 is a top plan view of the gripper device 130 of FIG. 2, but equipped with a cover plate 13 is to improve the appearance and safety, and to keep the user's fingers out of the pivot arm's 9 travel.

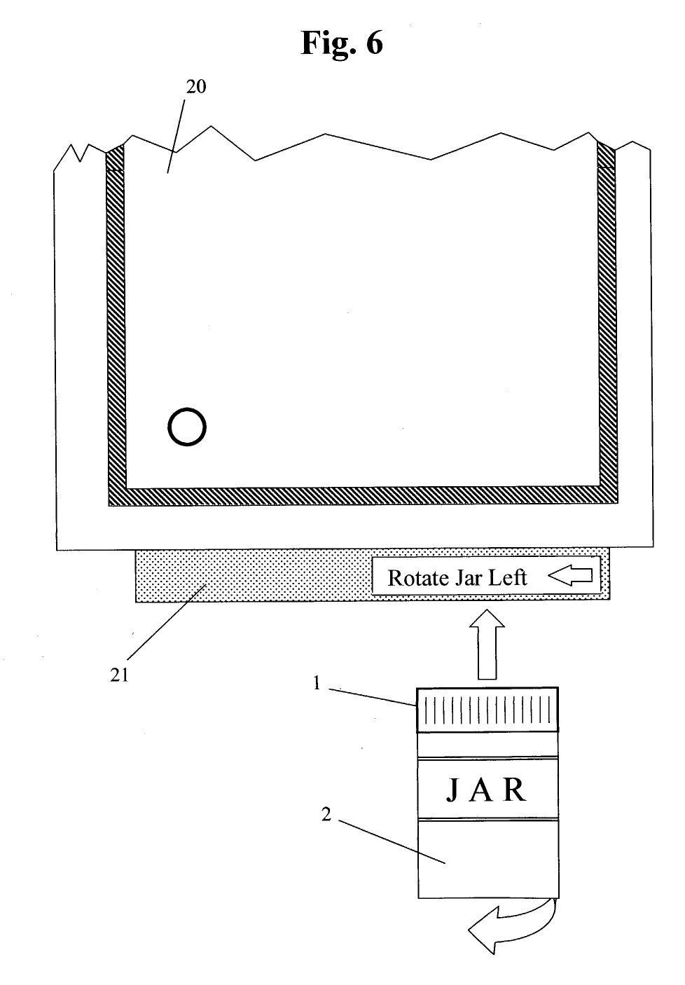

FIG. 6 is a front view showing the gripper device 130 of FIG. 2 mounted under a kitchen cabinet 20 for easy access. However, as noted above, the device 130 can be mounted on any axis, say on a closet wall. The materials for the invention can be of any rigid material such as plastic, steel, or aluminum. The invention can optionally be hinged on the edge of the cabinet facing the user. Such a hinge will permit the far edge of the gripper device 130 to swing down a predetermined angle (e.g. about 20 degrees) for easier viewing and use. In this example, the jar 2 would be inserted vertically into the invention till the lid 1 contacts with the baseplate 7. If a small diameter jar 2 is inserted, the jar 2 may have to be slide rearward till the lid 1 makes contact with the cinch strap 3 and then can be rotated to the user's left. This rotation will cause the lid 1 to bind with cinching strap 3, pulling the pivot arm 9 toward the lid 1 all while forcing the lid 1 to contact the fixed ridge 12. Once the jar 2 rolls down into a taunt cinch strap 3, additional rotational force is applied to the jar 2 to loosen the lid 1. Once the jar's 2 pressure seal is broken, the user simply rotates the jar 2 slightly to the right to free it and lowers the jar 2 from the invention. The spring 17 will return the pivot arm 9 to the open position to accept the next lid 1.

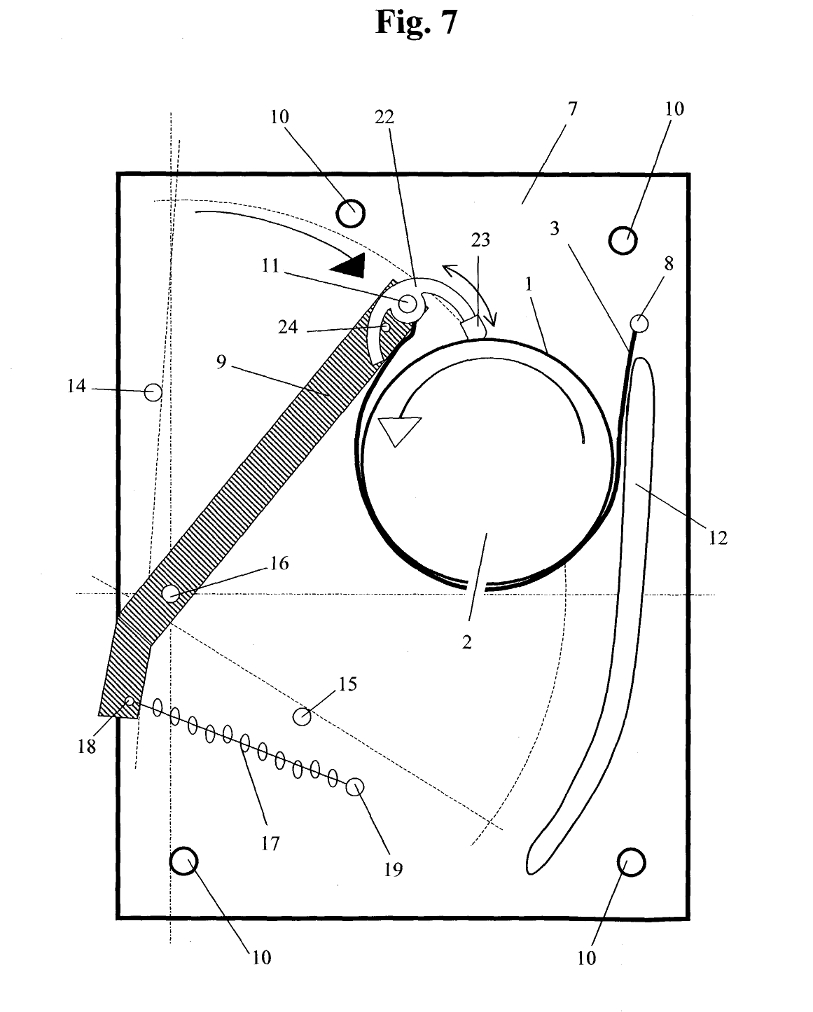

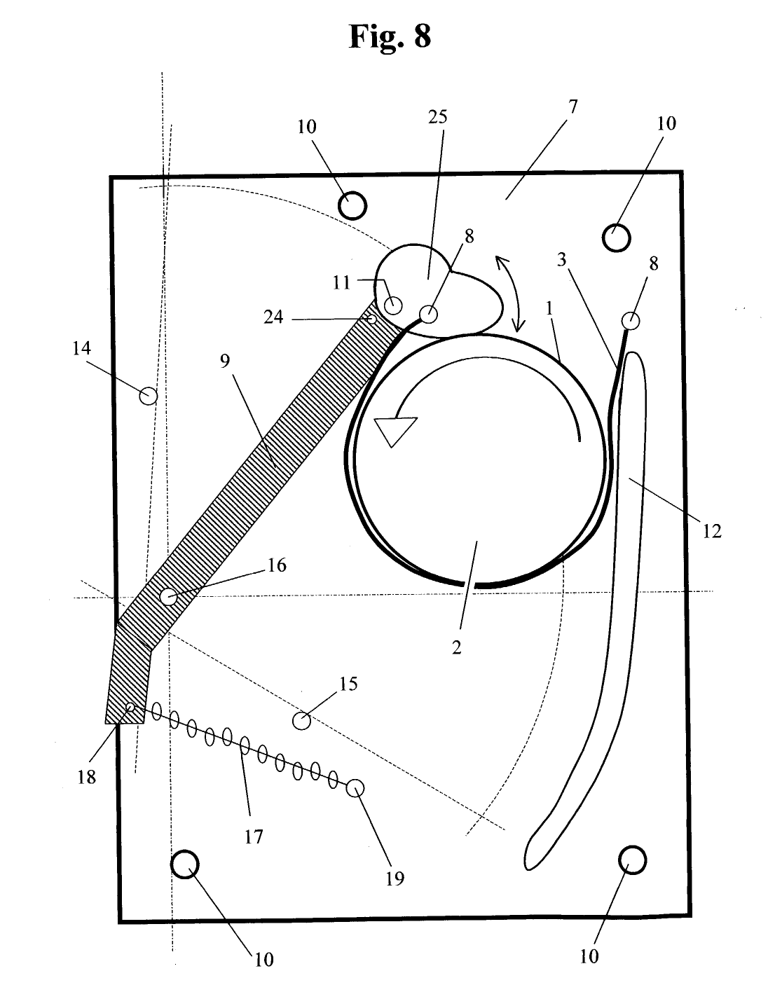

FIGS. 7 and 8, show two modifications of the embodiment of the invention of FIG. 2 having additional devices mounted to the end of the pivot arm 9. These devices are designed to exert a force directly onto the lid 1 as the cinching strap 3 pulls the pivot arm 9 down. The embodiment of FIG. 7 has a rocker arm 22 at the end of pivot arm 9. The rocker arm 22 can apply additional force on the lid 1. A rocker arm end 23 contact is the lid 1 and should be of a longer length than a trailing end 24 to follow the curve of the lid 1. This rocker arm end 23 contacting the lid 1 is further forced downward by the opposite arm being forced upward from contacting the cinching strap 3. The tip of rocker arm end 23 in contact with the lid 1 may be tipped with something for added friction, such as rubber or a gripping tooth.

FIG. 8 shows a cam 25 fitted to end of pivot arm 9. Cam 25 can be used to increase the force on the lid 1 during rotation. The cam's 25 surface facing the lid 1 will be a non-slip surface. The cinching strap 3 is mounted 8 on the cam 25 offset from the pivoting point 11. This will force the cinching strap 3 to bind tighter as the cam 25 contacts the counter-clockwise rotating lid 1 and the cam rotates clockwise. The rocker arm and cam can optionally be spring loaded to an open position of the stop 24.

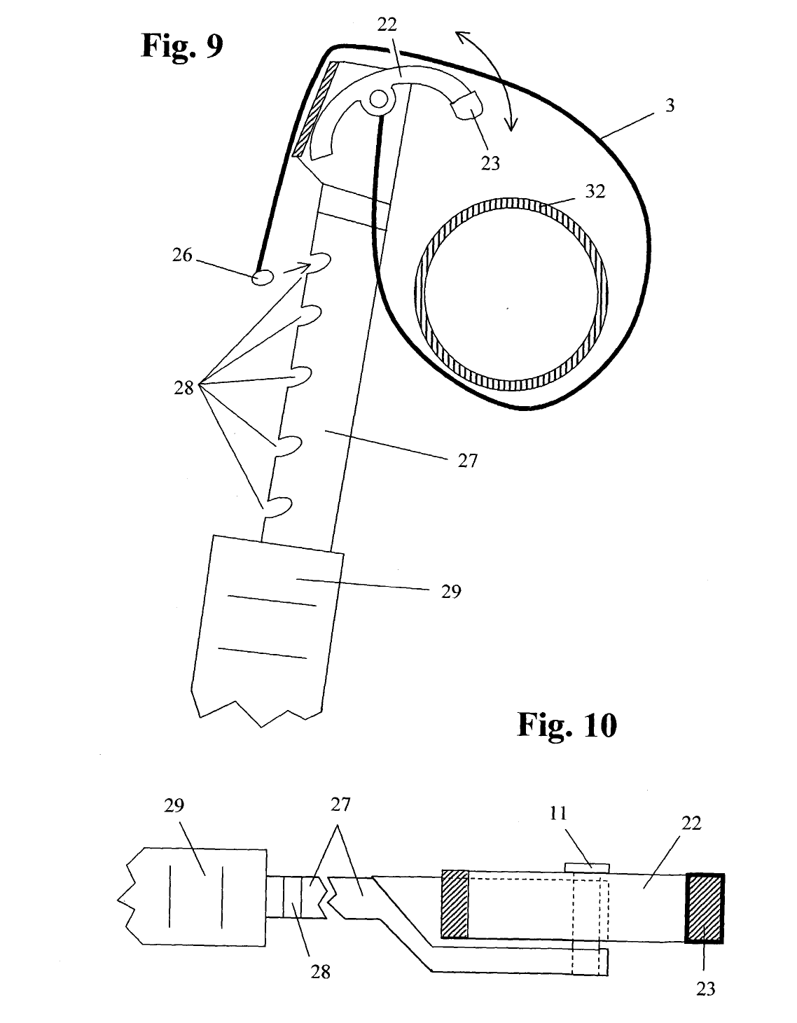

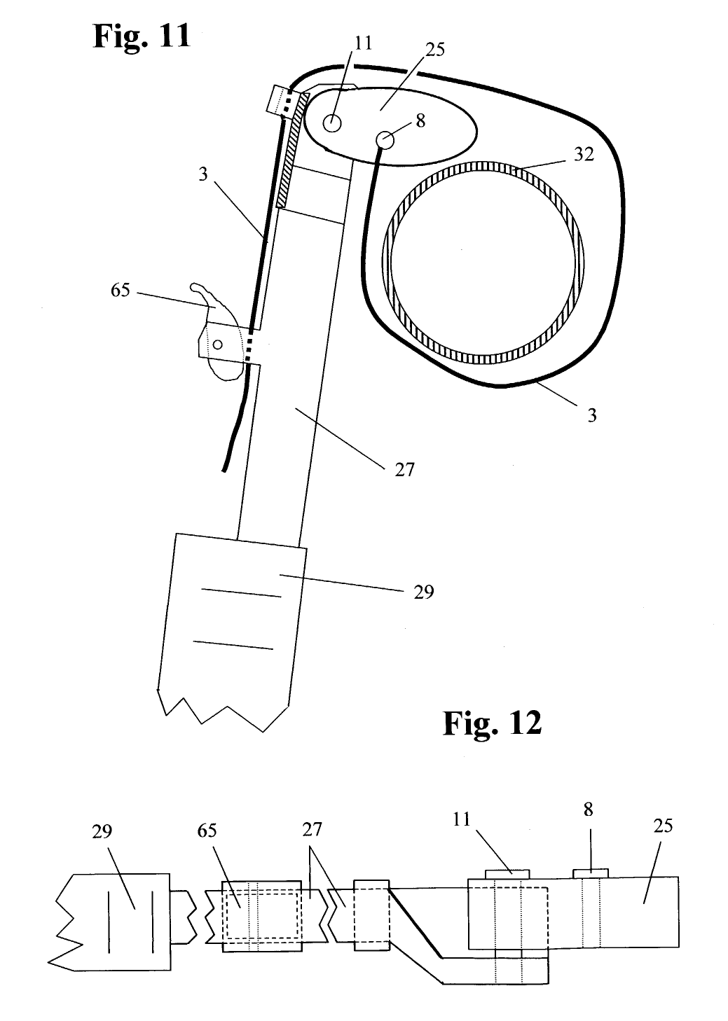

FIGS. 9 through 12 show two embodiments of gripper devices in the form of hand held wrench tools 140 and 150. These figures illustrate the use of a rocker arm 22 and a cam 25 (as used in the embodiment of FIGS. 7 and 8), to increase the mechanical advantage. These tools can be used for loosening or tightening any shape and virtually any sized object, limited only by the length of the cinching strap 3. The cinching strap 3 can have a button shaped retainer 26 at the free end which can be engaged with any number of slots 28 at various positions along a shank 27, to provide for various working lengths of the cinch strap. The cinching strap 3 can also be inserted in a lengthwise slot on the shank 27 and held in place by a cam shape mounted in the shank 27. The cinch strap's 3 slack can be pulled by the user to tighten the cinching strap 3 around the object to be rotated. Once the cinching strap 3 reverses pull when the wrench is rotated the cam engages and locks the cinching strap 3. The shank 27 can be made at any length, depending on the torque required for different jobs. The cinching strap 3 can be longer to match the proportion of the shank's 27 length. A handle 29 to which the shank 27 is attached can be ergonomically designed for the user's comfort. The handle 29 can be integral with shank 27 if desired.

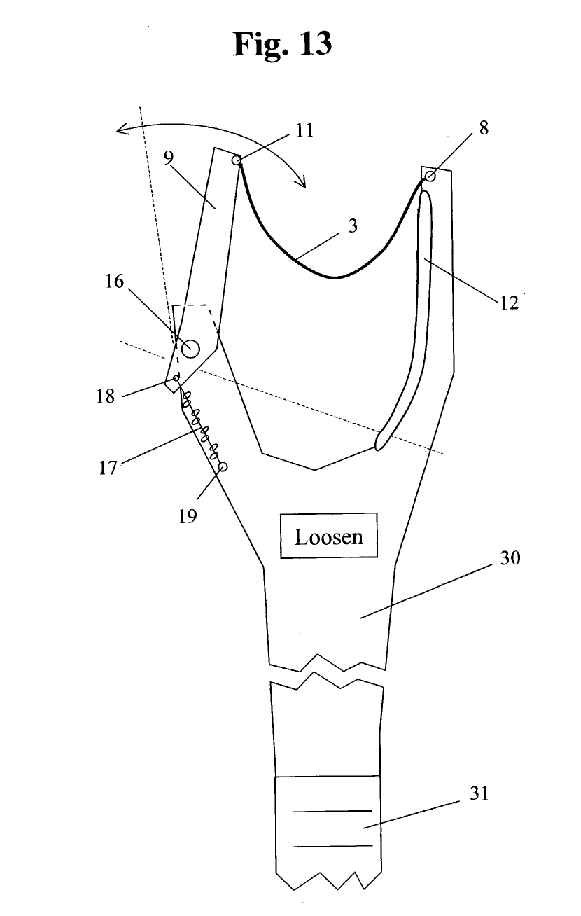

FIG. 13 shows another embodiment of the gripper device in the form of a pipe wrench 30 utilizing a pivoting swing arm 9 and a cinching strap 3. One advantage of this tool 30 is that there is no need for the user to have to adjust the wrench 30 before use with various sizes of pipe, etc. Shown in this figure is the side for loosening a pipe. To tighten a pipe, the user need just flip the wrench 30 over by 180 degrees. The wrench's handle 31 can be ergonomically designed for the user's comfort. The wrench 30 can be offered in various sizes to accommodate a range of pipe sizes. The cinching strap 3 can be replaceable to thereby extend the useful life of the wrench 30. The cinching strap 3 can be offered in soft rubber for delicate jobs, or even with metal links (e.g. steel or titanium links with grabbing teeth) for jobs requiring a strong turning force.

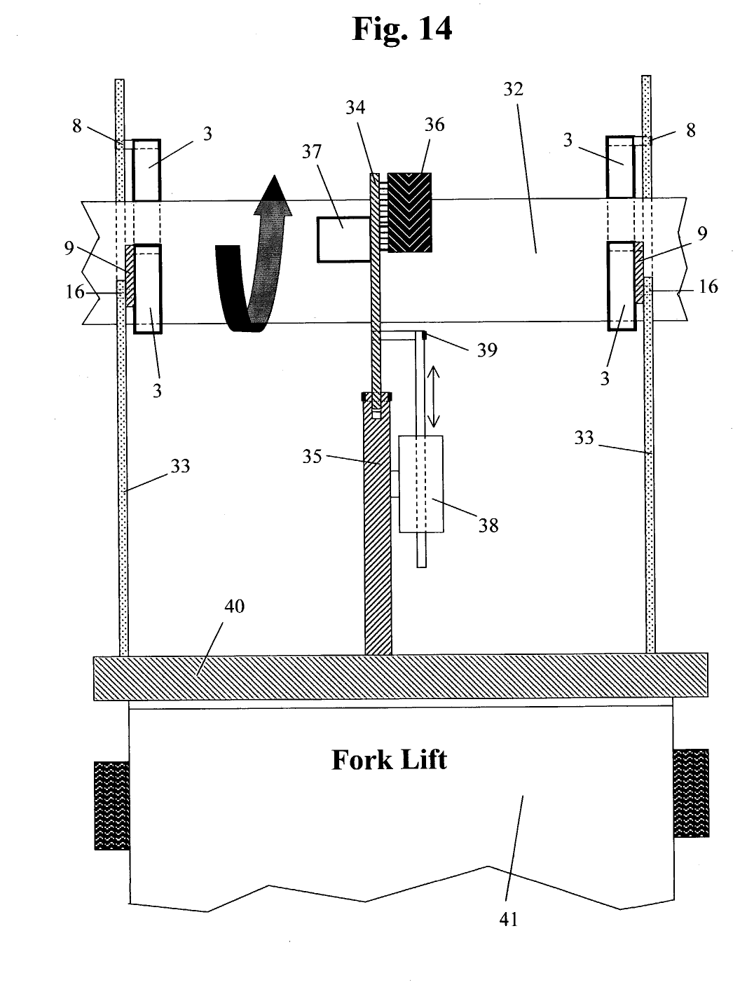

FIG. 14, the gripper device can be designed to accommodate a pipe 32 or bundle of objects for transport or rotation. FIG. 14 shows two gripper devices 33. The two cinch straps 3 can securely hold a pipe 32, e.g., in a level plane. Placed somewhere between the two gripper devices 33 is an articulating arm 34 with a drive belt 36 system. This articulating arm 34 can be hydraulically 38 powered to be extended and retracted. An electric motor driving a jack screw can suffice for extension and retraction of the articulating arm 34. The dashed outlined articulating arm 34 shows the device in the open position to accept a pipe 32. The articulating arm's 34 primary purpose is to grab the pipe and pull the pipe inwards toward the cinching straps 3. The drive belt's purpose is to rotate the pipe 32 counter-clockwise in this case, to engage the pipe with the cinching straps 3 and pivoting arms 9. The drive belt 36 is rotated with an electric motor 37 and series of gears. Once the pipe 32 is bound in place, the articulating arm 34 can assist in holding the pipe 32 in the cinching straps 3. The articulating arm 34 is mounted to a fixed arm 35, which is then mounted to a backplate 40. The two gripper devices 33 are also mounted to the backplate 40. The backplate 40 can be mounted to a forklift 41, tractor, lifting crane, robot arm. The benefit of this arrangement is safer movement and transport of pipe 32, etc. This arrangement will not scour or damage the pipe 32 being gripped. Other applications could include the delicate handling of glass test tubes or nuclear rods.

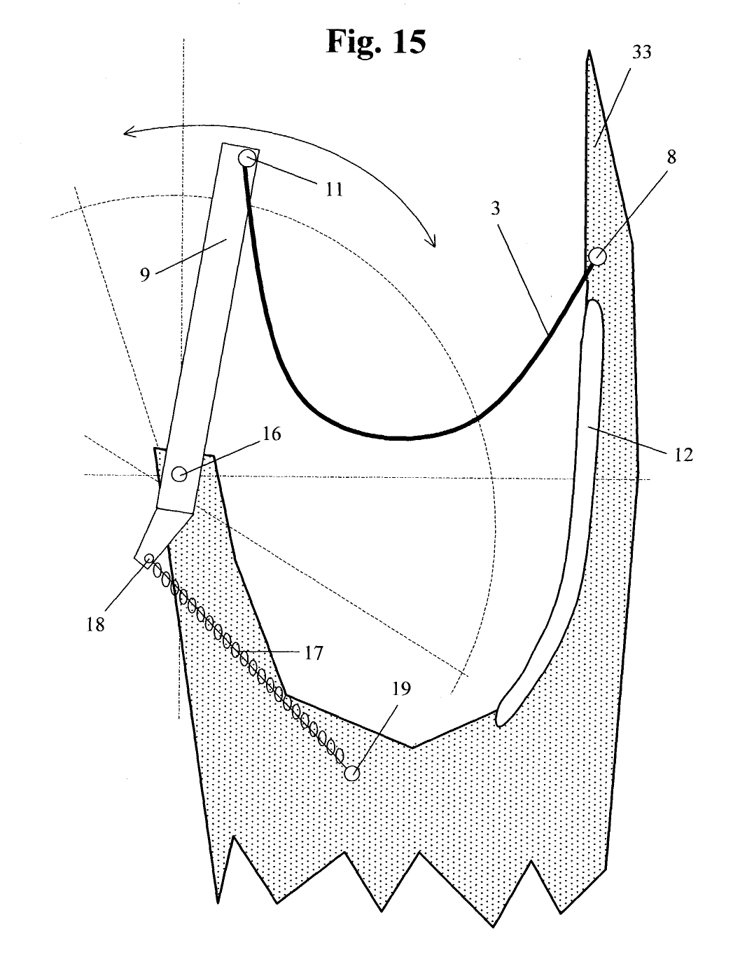

FIG. 15 shows a gripper device 170 that can be mounted on a plate 33 that is slightly different to accept pipe, etc. (not shown.) This plate 33 does not need a backplate (e.g., to limit the insertion of the jar lid as is the case with the earlier described gripper devices designed to loosen lids 1. The plate 33 is be mounted to the back plate 40.

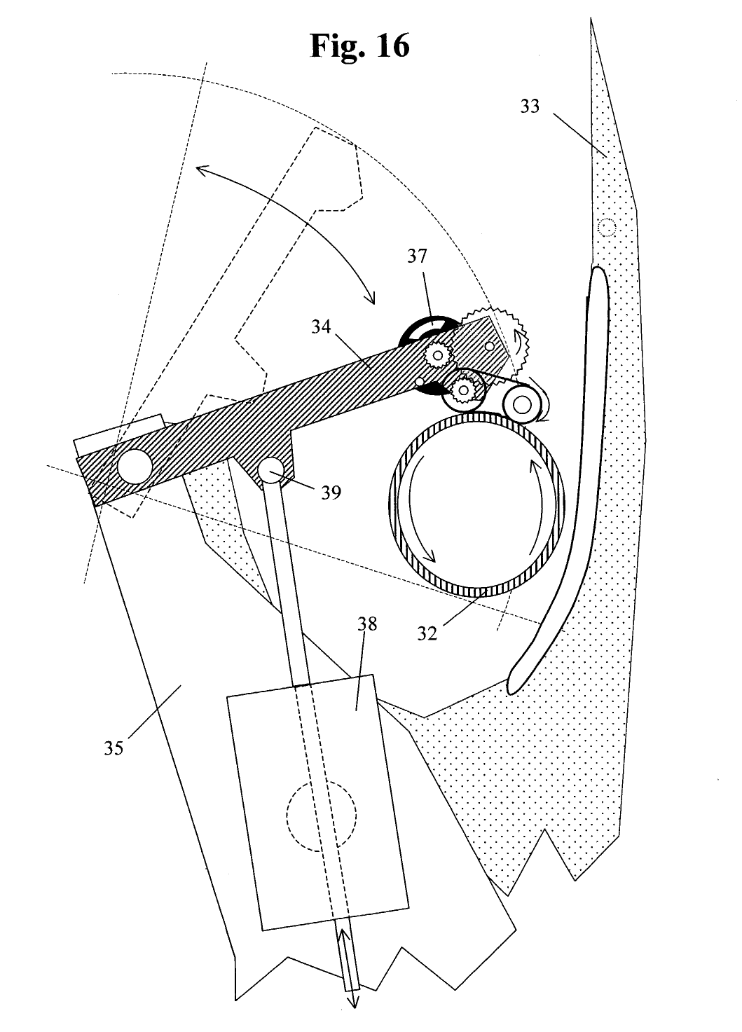

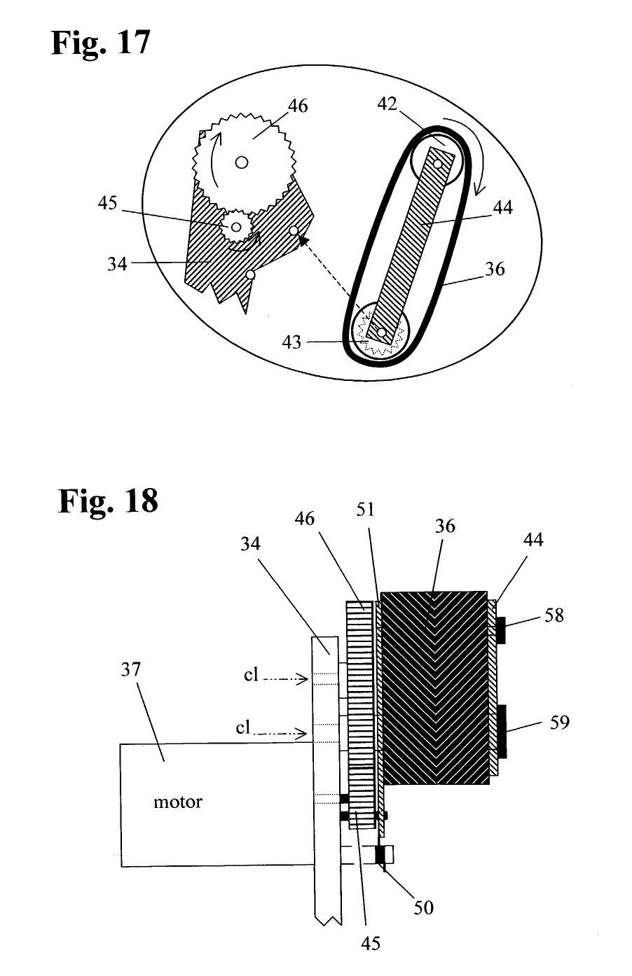

FIG. 16 is a schematic view showing the articulating arm 34 and the drive belt 36 capturing and rotating a pipe 32 in a counter-clockwise direction. The outline of the pivot arm mounting plate 33 is shown behind the articulating arm 34. The drive belt 36 is rotated through a series of gears 43, 45, and 46, as best shown in FIG. 17. The electric motor 37 is mounted to the articulating arm 34. The electric motor 37 is connected to and rotates the pinion gear 45. The spur gear 46 has a bearing 47 and is mounted to the articulating arm 34. The drive gear 43 for the belt 36 is attached to a splined inner barrel 53 by the means of a setscrew. The fixed arm 35 is mounted to the backplate 40.

Continuing with FIG. 17 and also FIG. 18, the drive gears 46, 45 and drive belt 36 are expanded for clarification. The pinion gear 45 is driven by the motor, which in turn rotates spur gear 46. The spur gear 46 drives the drive belt gear 43, which in turn rotates the drive belt 36.

FIG. 18 shows the assembled drive belt 36. Note the small gap between the spur gear 46 and the inner separator plate 51, allowing for free swivel of the drive belt 36 assembly.

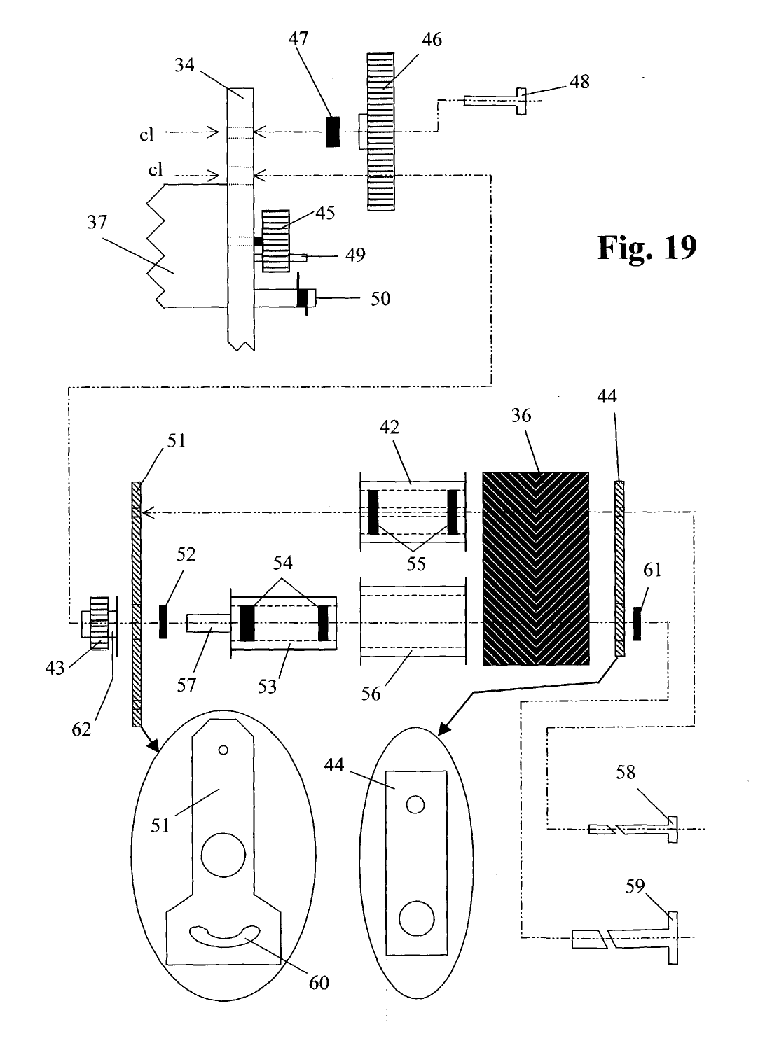

Lastly, turning to FIG. 19, there is shown an expanded top view illustrating how the drive belt 36 is assembled. The articulating arm 34 is shown in a vertical position with the motor 37 and pinion gear 45 mounted thereto. Mounted to the articulating arm 34 is a drive belt travel limit post 49 and a drive belt return spring 50. The drive belt travel limit post 49 fits in a slot 60 on an inner separator plate 51. The drive belt travel limit post 49 limits the upward and downward motion of the drive belt 36 assembly. The drive belt 36 assembly needs to swivel to accommodate various sizes of pipes 32. The drive belt return spring 50 repositions the drive belt 36 assembly to an upward position to accept pipe 32. The drive gear 43 slips onto a small diameter portion 57 of an inner drive barrel 53 and is secured with a set screw or similar method. The long length of the small diameter portion 57 of the inner drive barrel 53 acts as a spacer to separate the drive gear 43 away from the articulating arm 34. The drive belt gear 43 holds an inner separator plate 51 and a bearing 52 flush against the inner drive barrel 53. The small flange 62 between the drive belt gear 43 and the inner separator plate 51 is the distance required to separate a spur gear 46 and the inner separator plate 51. A bearing 52 will allow the inner drive barrel 53 to spin freely over a mounting bolt 59. The outer drive barrel 56 slips over the inner drive barrel 53, and has a splined surface between two drive barrels 53 and also 56 to transfer the rotation created by the drive belt gear 43. The rotation of the outer drive barrel 56 causes the drive belt 36 to rotate. An idler barrel 42 is free spinning assisted by bearings 55 and rides on a mounting bolt 58. The mounting bolt 58 threads into the inner separator plate 51, and should not flex as to keep the barrels 42 and 56 parallel and the drive belt 36 stretched taunt. The drive belt 36 is made from rubber or metal links and its outer surface is textured or has teeth to induce traction to the pipe 32. The drive belt 36 is slipped over the outer drive barrel 56 and the idler barrel 42 and then stretched so the barrels can be mounted in place. An outer separator plate 44 holds the barrels 42 and 46 parallel and is guide for the mounting bolts 58 and 59. A bearing 61 allows for swivel of the drive belt 36 assembly around the mounting bolt 59 without causing wear. Mounting bolt 59 threads into the articulating arm 34. By the clockwise direction of the drive belt 36 coming in contact with the pipe 32, the resultant force will pull the idler barrel 42 end of the drive belt 36 assembly toward the pipe 32, increasing friction on the pipe 32. The drive belt travel limiter post 49 will not allow the drive belt 36 assembly to rotate beyond a preset number of degrees if there is no contact made with the pipe 32.

The drawings in the foregoing description are not intended to represent the only form of the invention in regard to the details of its construction and manner of operation. In fact, it will be evident to one skilled in the art that modifications and variations can be made without departing from the spirit and scope of the invention. Although specific terms have been employed, they are intended in a generic and descriptive sense only and not for purposes of limitation.

What is claimed is:

1. A gripper device for loosening, tightening or gripping objects comprising:
a support structure having a fixed, object contact surface;
a cinch strap; and
a pivot arm pivoted at one end to the support structure and having a free end, wherein the cinch strap has one end mounted to the free end of the pivot arm, and another end that is fixable to the structure.

2. The gripper device of claim 1, wherein the object contact surface comprises a wall that is upraised from a plate portion of the support structure.

3. The gripper device of claim 1, wherein the cinch strap has a high friction surface to grip objects.

4. The gripper device of claim 1, wherein the pivot arm has one of a movable rocker arm and a cam positioned at its free end, which movable rocker arm or cam have a high friction surface.

5. The gripper device of claim 1, further comprising a spring to bias the rocker arm away from the fixed, object contact surface.

6. The gripper device of claim 1, wherein the support sturcture has a series of cinch strap engagement means to retain the end of the cinch strap not attached to the pivot arm.

7. The gripper device of claim 1, wherein the fixed, object contact surface and the pivot arm are connected to a handle.

8. The gripper device of claim 1, wherein the object contact surface has a non-slip surface.

9. The gripper device of claim 1, wherein the support structure can be mounted to any other surface.

10. The gripper device of claim 1, further comprising a hinge attached to the support structure to permit the gripper device to swivel or swing on the hinge.

11. A system for carrying generally cylindrical objects, comprising a plurality of spaced apart gripper devices as set forth in claim 1 and an articulating arm with a drive belt, which driver belt is adapted to rotate and bring object into contact with the cinch straps of the gripper devices to thereby cause the gripper devices to capture the objects.

12. The system for carrying generally cylindrical objects of claim 11 wherein the plurality of spaced apart gripper devices and the articulating arm with a drive belt are affixed to a frame, which frame can be attached to a forklift or crane.
